(19) United States
(12) Patent Application Publication
(10) Pub. No.: US 2015/0252874 A1
(43) Pub. Date: Sep. 10, 2015

(54) DEVICE FOR ACTUATING ONE OR MORE MOVING PARTS, NOTABLY FOR A MOTOR VEHICLE TURBOCHARGER

(71) Applicant: VALEO SYSTEMES DE CONTROLE MOTEUR, Cergy Saint Christophe (FR)

(72) Inventors: Pierre Lemercier, Paris (FR); Gabriel Ridolfi, Cergy (FR)

(73) Assignee: Valeo Systemes De Controle Moteur, Cergy Saint Christophe (FR)

(21) Appl. No.: 14/438,056

(22) PCT Filed: Oct. 21, 2013
(86) PCT No.: PCT/FR2013/052503

§ 371 Date: Apr. 23, 2015

(30) Foreign Application Priority Data
Oct. 24, 2012 (FR) 1260143

(51) Int. Cl. F16H 1/20; H02K 7/116; F16H 57/029; H02K 5/22; F16H 57/021; F16H 57/031

(52) U.S. Cl. CPC F16H 1/20; F16H 57/021; F16H 57/031; F16H 57/029; H02K 5/225; H02K 7/116; F16H 2057/02034

(57) ABSTRACT

The invention relates to a device for actuating one or more moving parts, notably for a motor vehicle turbocharger, said device comprising a drive shaft, an output shaft and a transmission system transmitting torque from said drive shaft to said output shaft, said drive train comprising at least one wheel (8a,8b) transmitting torque from said drive shaft to said output shaft, said drive and output shafts and said transmission wheel or wheels (8a, 8b) being able to rotate about respective pivot axes (10m, 10a, 10b, 10s). According to the invention, the pivot axis of at least one of said transmission wheels (8a, 8b) is offset from a plane P passing through the pivot axis of said drive shaft and output shaft.

The invention relates to a device for actuating one or more moving parts and an assembly consisting of such an actuating device and the moving part(s) intended to be actuated by the said device. It will find an application, in particular, in the sector of turbochargers for adjustment of the position of the turbine blades. Numerous other applications, however, are possible.

In this sector, pneumatic actuators are known. However, they do not always offer the best compromise in terms of performance and price, in particular in the case of low-cost applications in severely stressed environments such as applications underneath the hood in motor vehicles.

Thus, in some cases, actuators which use an electric motor are preferred instead of them. In this sector actuating devices comprising a drive shaft, an output shaft and a transmission system for transmitting the torque from the drive shaft to the output shaft by means of transmission wheels are known. The transmission system allows the reduction ratio between drive shaft and output shaft to be fixed.

In this case, as in the case of the air supply valves of a vehicle heat engine, where the moving part(s) actuated by the valve, such as flaps, are hinged parallel to a motor for driving said drive shaft, the transmission system also ensures that there is sufficient spacing between the drive shaft and the output shaft so as to allow for the displacement of the output members. The pivot axes of the drive shaft, the transmission wheels and the output shaft are therefore in the same plane. In other words, viewed in a plane perpendicular to the said pivot axes, they are aligned.

There remains, however, a need for more compact actuating devices.

To this end the invention proposes a device for actuating one or more moving parts, in particular for a motor vehicle turbocharger, the said device comprising a drive shaft, an output shaft, and a transmission system for transmitting a torque from the said drive shaft to the said output shaft, the said transmission system comprising at least one wheel for transmitting the torque from the said drive shaft to the said output shaft, the said drive shaft and output shaft and the said transmission wheels(s) being rotatable about respective pivot axes.

According to the invention the pivot axis of at least one of the said transmission wheels is offset from a plane passing through the pivot axis of the said drive and output shafts. Using pivot axes positioned in this way, the device occupies a limited amount of space since the transmission members, viewed in a plane perpendicular to the said pivot axes, are better distributed, this for the same reduction ratio.

The said pivot axes are advantageously positioned so that a line radially connecting the said pivot axes is a broken line changing direction at each pivot axis.

According to a first aspect of the invention, the said device may comprise a motor for rotationally driving the drive shaft, in particular an electric motor, the said motor being provided with at least two power supply connectors projecting from the said motor with a component parallel to the said drive shaft, in particular parallel to the said motor. With such an embodiment it is possible to direct the torque transmission members of the said device and the electrical connectors of its motor in the same direction, this allowing the power supply system of the motor driving said members and control thereof to be achieved with a small number of parts and in a limited space.

The said connectors may be advantageously positioned inside an angular sector formed extending from the pivot axis of the drive shaft and forming an angle of less than 180°, in particular less than 120°, and even less than 90°. According to this latter characteristic feature, the compact nature of the device is further improved.

In this connection, one wheel, i.e. a first wheel, of the said transmission wheels may advantageously mesh with the said drive shaft and one or more other transmission wheels of the said transmission system are located at least partly vertically aligned with the said drive motor. It is thus possible to take full advantage of the arrangement of the connectors as envisaged further above.

This having been said, according to this first aspect of the invention, the following characteristic features, considered together or separately, may be used:
the said device comprises a body defining a seat inside which the said drive shaft and/or the said output shaft protrude and/or inside which the said transmission system is situated;
the said device comprises a cover for closing the said seat, the said cover comprising elements for electrical connection to the said connectors and/or an angular position sensor cooperating with the said drive shaft, the said output shaft and/or the said transmission system,
the said electrical connection elements and/or the said angular sensor are overmolded on the said cover.

According to another aspect of the invention, which may be combined with the preceding aspect, the said transmission wheel(s) comprise respectively a shaft for rotatably mounting the said transmission wheels about their pivot axis. The said transmission system comprises an output wheel, connected to the said output shaft. The said device further comprises, on the one hand, sleeves for pivotably mounting the shaft of the said transmission wheel(s) and/or the said output shaft, and, on the other hand, a spacer arranged between one of the said sleeves, i.e. short sleeve, and the wheel of the said transmission and/or output wheels, i.e. raised wheel, pivotably mounted on the said short sleeve, along the pivot axis of the said raised wheel.

The said spacer has an external diameter smaller than an external diameter of the said short sleeve. With such an arrangement it is possible to improve further compactness by allowing greater overlapping of the transmission wheels.

It can moreover be noted that these characteristics allow the compactness to be improved without the pivot axes of the transmission members being situated in offset planes and the invention also relates to an actuating device having the said characteristics whatever the positioning of the said pivot axes.

This having been said, according to this other aspect of the invention, the following characteristics may be used, together or separately:
the sleeves of the transmission wheels have a height, along the pivot axis of the corresponding wheel, similar from one sleeve to another;
the said raised wheel meshes with one—adjacent—wheel of the said other transmission wheels, comprising a small pinion and a large pinion, the said small pinion meshing with the said raised wheel and the said large pinion being positioned so as to rotate opposite the said spacer;
the said large pinion has a radial extension greater than the distance between the pivot axis of the wheel carrying the said small and large pinions and the closest point of the external diameter of the said short sleeve.

The said device may also comprise a crank designed to actuate the said moving parts using the torque supplied by the said output shaft.

The invention also relates to an assembly consisting of the actuating device as described further above and the moving part(s) intended to be actuated by the said device.

Further characteristic features and advantages of the invention will become clear from a reading of the description which follows and which relates to detailed examples of embodiment, with reference to the attached figures in which, respectively:

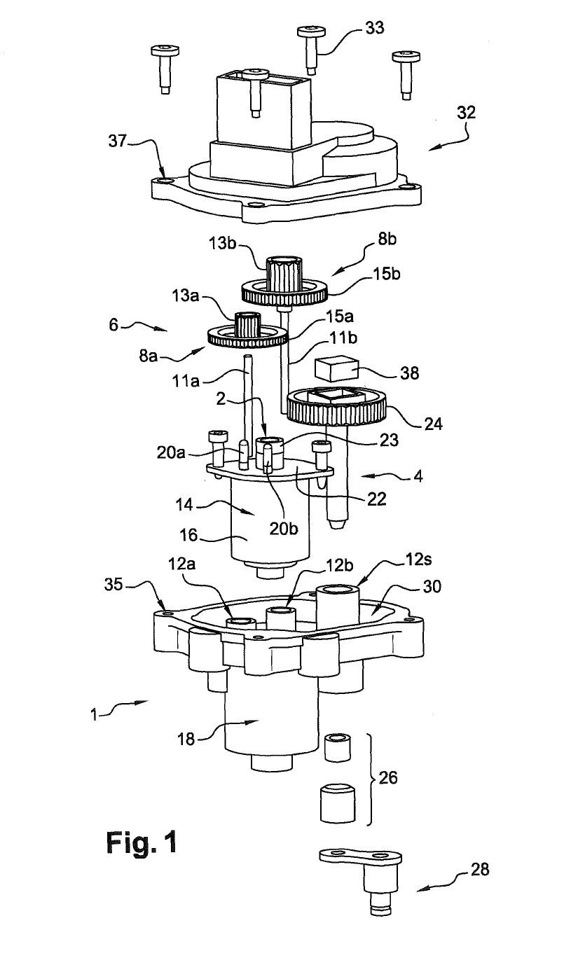

FIG. 1 is an exploded perspective view of an example of embodiment of an actuating device according to the invention;

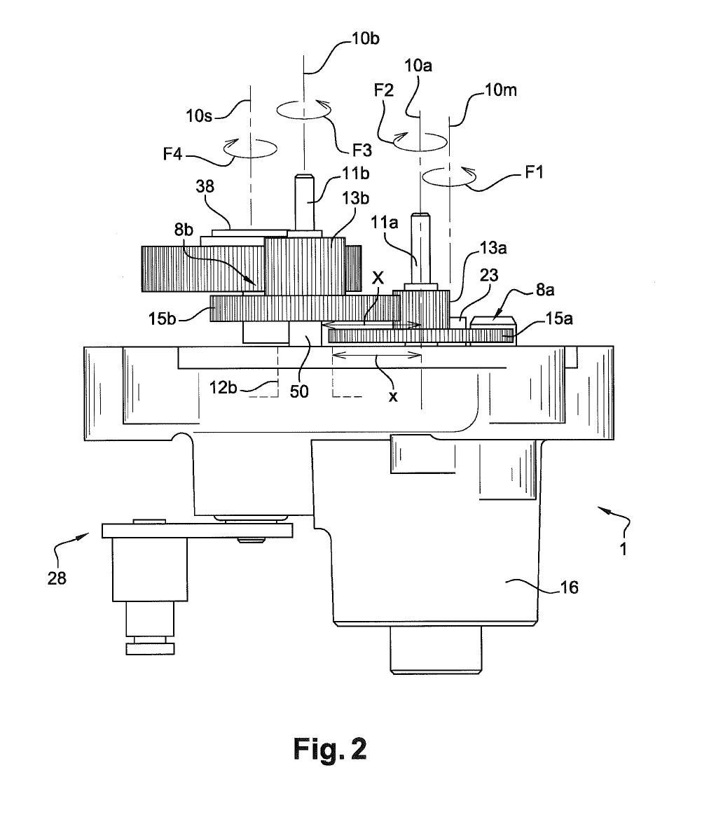

FIG. 2 is a side view of the device according to FIG. 1, in the assembled condition, the said device being shown without cover;

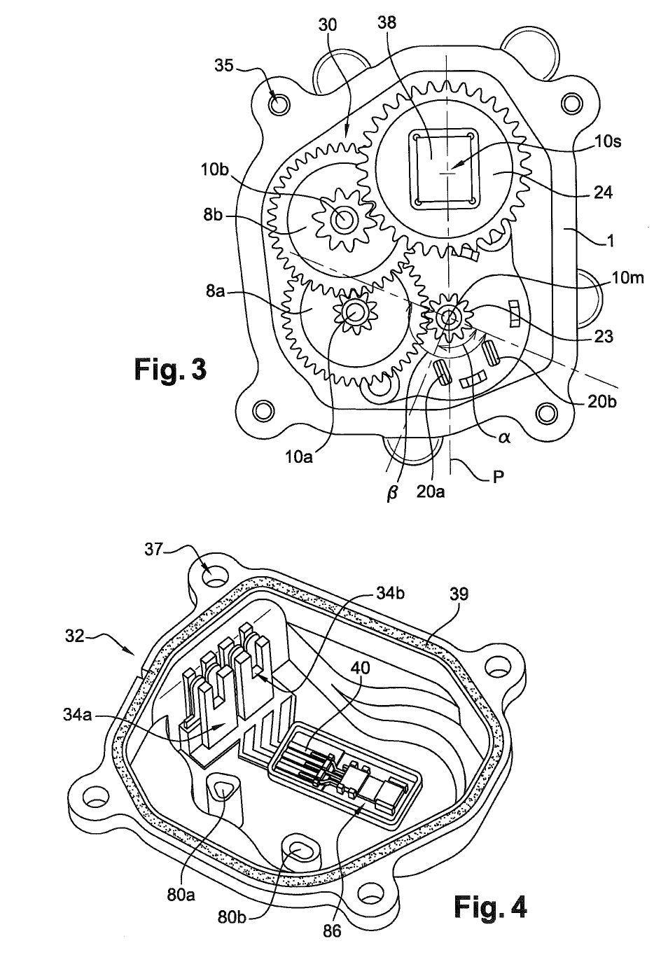

FIG. 3 is a top plan view of FIG. 2;

FIG. 4 shows a perspective view, from below, of the cover of the device according to the preceding figures.

The invention relates to a device for actuating one or more moving parts. These parts may consist, for example, of the turbine blades of a turbocharger, in particular of a motor vehicle, the direction of which is to be changed, in particular depending on the exhaust gas flowrate inside the said turbine. This having been said, numerous other moving parts may be actuated by the device according to the invention, in particular rotatable moving parts.

As shown in FIGS. 1 and 2, the said device comprises here a body 1, in particular a body obtained by means of casting. The said body 1 is, for example, made of aluminum and/or an aluminum alloy.

The said device comprises a drive shaft 2, an output shaft 4 and a transmission system 6 for transmitting a torque from the said drive shaft 2 to the said output shaft 4. The said transmission system 6 comprises at least one—in this case two—wheel(s) 8a, 8b for transmitting the torque from the said drive shaft 2 to the said output shaft 4. Said wheels consist, for example, of toothed wheels comprising several pinions, more particularly, toothed wheels comprising at least one small pinion 13a, 13b associated coaxially, on a pivoting shaft 11a, 11b, with a large pinion 15a, 15b, the said small pinion of one of the wheels meshing with the large pinion of an adjacent wheel.

The said drive shaft 2 and output shaft 4 and the pivot shaft 11a, 11b of the said transmission wheel(s) 8a, 8b, as well as any associated pinion(s), are rotatable about respective pivot axes 10m, 10a, 10b, 10s, which here are parallel to each other. The said device may further comprise sleeves 12a, 12b, 12s for pivotably mounting the shaft 11a, 11b of the said transmission wheels 8a, 8b and/or the said output shaft 4. The said sleeves 12a, 12b, 12s may extend from the said body 1.

The said device further comprises here a motor 14, in particular an electric motor, for rotatably driving the said drive shaft 2. Said motor consists, for example, of a motor, the stator and rotor of which (not visible) are housed inside a cylindrical housing 16. By way of a variant, the motor may consist, among other thing, of a motor with a flatter configuration also known by the name of a flat motor. The said motor 14 is housed here inside a cavity 18 of the body 1 which has a complementary shape.

The said motor 14 may be provided with at least two electric power supply connectors 20a, 20b projecting from the said motor 14 parallel to the said drive shaft 2. In other words, they extend in the same direction, here perpendicularly with respect to a same longitudinal end face 22 of the said motor 14. The connectors consist here, for example, of flat metal pins.

The said drive shaft 2 forms an axial extension of the rotor of the said motor 14 and terminates in a pinion 23 meshing with the transmission system 6.

The said transmission system 6 comprises here an output wheel 24 connected to the said output shaft 4. The pinion 23 of the drive shaft, the pinions 15a, 15b, 13a, 13b of the transmission system for transmitting the torque and the said output wheel 24 determine a reduction ratio, chosen depending on the intended application.

The said device may also comprise bearings and/or a sealing gasket 26 mounted between the said body 1 and the said output wheel 24, in particular inside the said corresponding mounting sleeve 12s. It may also comprise a crank 28 designed to actuate the moving part(s) using the torque supplied by the said output shaft 4. It can be noted that the said crank 28 allows a radially offset arrangement such that the housing 16 inside which the said motor 16 is housed does not interfere with the displacement of the associated moving part(s). By way of a variant, an axially offset arrangement beyond the housing 16 is possible.

The said actuating device may be driven by a control unit, not shown, for driving the said crank 28 rotatably so as to cause a movement of the moving parts connected to the said crank 28, depending on the characteristics of the current supplied to the motor 14. More precisely, here, the power supply of the motor 14 causes rotation of the drive shaft 4, in the direction of the arrow indicated by Fl, this causing via its pinion 23, the rotation of the first wheel 8a of the transmission wheels, in the direction of the arrow indicated by F2, this then causing the rotation of the other—second—wheel 8b of the transmission wheels, in the direction of the arrow indicated by F3, this causing finally rotation of the output shaft 4 and consequently the said crank 28, in the direction of the arrow indicated by F4, by means of the said output wheel 24.

As can be seen more clearly from FIG. 3, according to the invention, the pivot axis 10a, 10b of at least one of the said transmission wheels 8a, 8b is offset from a plane P passing through the pivot axis 10m, 10s of the said drive shaft and output shaft, here connected to the said pinion 23 and to the said output wheel 24. In other words, the said pivot axes 10a, 10b of the said transmission wheel(s) 8a, 8b do not lie within the said plane P. This thus favors the compactness of the valve owing to a better distribution of the transmission members within the plane of the figure.

Advantageously, the said pivot axes 10m, 10a, 10b, 10s are positioned so that a line connecting radially the said pivot axes is a broken line changing direction at each pivot axis 10m, 10a, 10b, 10s. In other words, in the plane of FIG. 3, the said line forms a polygon, here a quadrilateral, the vertices of which are the said pivot axes 10m, 10a, 10b, 10s. In particular it may consist of a quadrilateral with a substantially trapezoidal shape. The said connectors 20a, 20b of the motor 14 may be positioned inside an angular sector a formed extending from the pivot axis 10m of the drive shaft 2 and forming an angle of less than 180°, in particular less than 120°, here about 90°. Such an arrangement allows the compactness of the device to be further improved.

More particularly, the first wheel 8a of the said transmission wheels meshes with the drive shaft 2, and the pivot axis 10a of the said first wheel 8a and the said connectors 20a, 20b are positioned inside an angular sector p formed extending from the pivot axis 10m of the drive wheel 2 and forming an angle of less than 180°.

Advantageously, owing to the smaller angular sector inside which the connectors 20a, 20b are positioned, one or more other wheels of the said transmission system 6, in particular the said second transmission wheel 8b and/or the said output wheel 24, are positioned at least partly vertically aligned with the said drive motor 14, in particular vertically aligned with the longitudinal end face 22 of the said motor 14, from where the said connectors 20a, 20b protrude.

The said body 1 defines here a seat 30 inside which the drive shaft 2 and/or the said output shaft 4 emerge and/or inside which the said transmission system is situated. The said device may also comprise a cover 32, visible in FIG. 1, for closing said seat 30. The said cover 32 is fixed here onto said body 1 by means of screws 33 which are engaged inside tapped holes 35 of the said body 1 via orifices 37 in the said cover 32. A sealing gasket 39 (FIG. 4) may be positioned between the said body 1 and the said cover 32 in order to improve the tightness of the seat 30.

As is shown more clearly in FIG. 4, the said cover comprises elements 34a, 34b, in particular terminals, for electrical connection with the said connectors 30a, 30b. It also comprises in this case an angular position sensor 86, in particular a Hall probe, cooperating with the said output shaft 6, for example by means of magnetic target plate 38 situated on the latter (FIG. 3). By way of a variant, the said magnetic target plate may be situated on the said drive shaft and/or a member of the said transmission system 6, positioning of the Hall probe on the cover in this case obviously being adapted.

The said electrical connection elements 34a,34b and/or the said angular sensor 86 are, for example, overmolded on the said cover 32, here alongside electric tracks 40 of an electric circuit comprising the said electrical connection elements 34a, 34b and/or the said angular sensor 86.

As shown in FIG. 2, the said device comprises advantageously a spacer 50 arranged between one of the said sleeves 12b, i.e. short sleeve, the external contour of which is shown in broken lines in the said figures, and the wheel of the said transmission wheels, here the second wheel 8b, i.e. raised transmission wheel, pivotably mounted on the said short sleeve 12b, along the pivot axis 10b of the said raised wheel 8b.

The said spacer 50 advantageously has an external diameter smaller than an external diameter of the said short sleeve 12b. Such a characteristic features further favors the compactness of the device. The spacer 50 is here formed as one piece with the raised wheel 8a. The sleeves 12a, 12b of the transmission wheels 8a, 8b have a height, along the pivot axis of the corresponding wheel, similar from one sleeve to another.

The large pinion 15b of the raised wheel 8b meshes with the small pinion 13a of the first transmission wheel 8a, the large pinion 15a of the said first wheel 8a being positioned so as to rotate opposite the said spacer 50. The said large pinion 15a of the said first wheel 8a has a radial extension X greater than the distance x between the pivot axis 10a of the said first wheel 8a and the closest point of the external diameter of the said short sleeve 12b. From FIG. 2 it is possible to appreciate better the advantage obtained in terms of compactness by such characteristic features which may obviously applied also to other wheels of the device according to the invention.

The said cover 32 comprises here sleeves 80a, 80b which are formed as one piece for receiving top ends of the pivoting shafts 11a, 11b of the said transmission wheels 8a, 8b.

1. A device for actuating one or more moving parts for a motor vehicle turbocharger, the device comprising:
a drive shaft;
an output shaft;
a transmission system for transmitting a torque from the drive shaft to the output shaft,
the transmission system comprising at least one wheel for transmitting the torque from the drive shaft to the output shaft, the said drive shaft and output shaft and the transmission wheel(s) being rotatable about respective pivot axes, the pivot axis of at least one of the transmission wheels being offset from a plane passing through the pivot axis of the drive shaft and output shaft; and
a motor for rotationally driving the drive shaft and wherein the motor is provided with at least two power supply connectors projecting from the motor parallel to the drive shaft and positioned inside an angular sector formed extending from the pivot axis of the drive shaft and forming an angle of less than 180°.

2. The device as claimed in claim 1, wherein the pivot axes are positioned so that a line radially connecting the pivot axes is a broken line changing direction at each pivot axis.

3. The device as claimed in claim 1, wherein the angular sector is less than 120°.

4. The device as claimed in claim 1, wherein a first wheel of the at least one transmission wheel meshes with the drive shaft and wherein one or more other transmission wheels of the transmission system are located at least partly vertically aligned with the drive motor.

5. The device as claimed in claim 1, further comprising a body defining a seat inside which the drive shaft and/or the output shaft protrude and/or inside which the transmission system is situated.

6. The device as claimed in claim 5, further comprising a cover for closing the seat, the cover comprising elements for electrical connection to the connectors and/or an angular position sensor cooperating with the drive shaft, the output shaft and/or the transmission system.

7. The device as claimed in claim 6, wherein the electrical connection elements and/or the angular sensor are overmolded on the cover.

8. The device as claimed in claim 1, wherein the at least one transmission wheel(s) comprise respectively a shaft for rotatably mounting the transmission wheel(s) about their pivot axis and/or the transmission system comprises an output wheel, connected to the output shaft, the device further comprising:
sleeves for pivotably mounting the shaft of the transmission wheel(s) and/or the output shaft and,
a spacer arranged between one of the sleeves known as a short sleeve, and one of the at least one wheel of the transmission system or the output wheel, is a raised wheel that is pivotably mounted on the short sleeve, along the pivot axis of the raised wheel, the spacer having an external diameter smaller than an external diameter of the short sleeve.

9. The device as claimed in claim 8, wherein the sleeves of the transmission wheels have a height, along the pivot axis of the corresponding wheel, similar from one sleeve to another.

10. The device as claimed in claim 8, wherein the raised wheel meshes with one wheel of the other transmission wheels, comprising a small pinion and large pinion, the small pinion meshing with the raised wheel and the large pinion being positioned so as to rotate opposite the spacer.

11. The device as claimed in claim 10, wherein the large pinion has a radial extension greater than a distance between the pivot axis of the wheel carrying the small and large pinions and the closest point of the external diameter of the short sleeve.

12. The device as claimed in claim 1, comprising a crank designed to actuate the moving part(s) using the torque supplied by the output shaft.

13. An assembly consisting of the actuating device according to claim 1 and the moving part(s) intended to be actuated by the device.
